(19) United States
(12) Patent Application Publication
(10) Pub. No.: US 2010/0332812 A1
(43) Pub. Date: Dec. 30, 2010

(54) METHOD, SYSTEM AND COMPUTER-ACCESSIBLE MEDIUM FOR LOW-POWER BRANCH PREDICTION

(76) Inventors: Doug BURGER, Redmond, WA (US); Renee ST. AMANT, Austin, TX (US)

Correspondence Address: DORSEY & WHITNEY LLP;INTELLECTUAL PROPERTY DEPARTMENT, 250 PARK AVENUE, NEW YORK, NY, 10177, US

(21) Appl. No.: 12/490,918

(22) Filed: Jun. 24, 2009

(51) Int. Cl. G06F 9/38

(52) U.S. Cl. 712/239; 712/E09.045

(57) ABSTRACT

Examples of a method, system, and computer-accessible medium are provided which can utilize a neural branch predictor on, e.g., an analog circuit. For example, a current summation can be used instead of the digital dot-product generally used in traditional neural predictor designs. A scaling factor may also be used to increase prediction accuracy.

### STATEMENT REGARDING GOVERNMENT SPONSORED RESEARCH

The invention was made with the U.S. Government support, at least in part, by the Defense Advanced Research Projects Agency, Grant number F33615-03-C-4106. Thus, the U.S. Government may have certain rights to the invention.

### BACKGROUND

In a computer architecture, a branch predictor can be a part of a processor that determines whether a conditional branch in the instruction flow of a program is likely to be taken or not taken. This may be called a branch prediction. Branch predictors are important in today's modern, superscalar processors for achieving a high performance, and can facilitate the processors to fetch and execute instructions without waiting for a branch to be resolved. Most of pipelined processors perform branch predictions of some form, because they should guess the address of the next instruction to fetch before the current instruction has been executed.

Branch prediction remains one of the important components of high performance in processors that exploit a single-threaded performance. Modern branch predictors can achieve high accuracies on many codes, but further developments are needed if processors are to continue improving the single-threaded performance. Accurate branch prediction shall remain important for general-purpose processors, especially as the number of available cores exceeds the number of available threads.

Neural branch predictors—a class of correlating predictors that make a prediction for the current branch based on the history pattern observed for the previous branches using a dot product computation—have shown some promise in attaining high prediction accuracies. Neural branch predictors, however, have traditionally provided poor power and energy characteristics due to the computation requirement. Certain proposed designs have reduced predictor latency at the expense of some accuracy, but such designs remain uncompetitive from a power perspective. The requirement of computing a dot product for every prediction, with potentially tens or even hundreds of elements may not be suitable for an industrial adoption in the current form.

### BRIEF DESCRIPTION OF THE FIGURES

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a block diagram of an illustration of a computing system in accordance with one example.

FIG. 2 is a block and functional diagram of an illustration of a neural branch predictor in accordance with one example.

FIG. 3 is a schematic and functional diagram of an illustration of an analog neural branch prediction scheme in accordance with one example.

FIG. 4 is a flowchart and block diagram of an illustration of a suitable method in accordance with one example.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are implicitly contemplated herein.

This disclosure is drawn to methods, apparatus, computer programs and systems related to branch prediction. Certain preferred embodiments of one such system are illustrated in the figures and described below. Many other embodiments are also possible, however, time and space limitations prevent including an exhaustive list of those embodiments in one document. Accordingly, other embodiments within the scope of the claims will become apparent to those skilled in the art from the teachings of this patent.

The figures include numbering to designate illustrative components of examples shown within the drawings, including the following: a computer system 100, a processor 101, a system bus 102, an operating system 103, an application 104, a read-only memory 105, a random access memory 106, a disk adapter 107, a disk unit 108, a communications adapter 109, an interface adapter 110, a display adapter 111, a keyboard 112, a mouse 113, a speaker 114, a display monitor 115, an analog branch predictor 200, a table of perceptrons 201, a branch history register 202, a hash function 203, a dot product 204, a bias weight 205, an updated weights vector 206, a weights vector 207, digital to analog converters 401, current splitters 402, current to voltage converters 403, comparators 404, a comparator output 411, training outputs 412 and 413, a magnitude line 422, current lines 423, a weight bias 424, a current source 450, a bias transistor 451, a ground 460, and an XOR function 465.

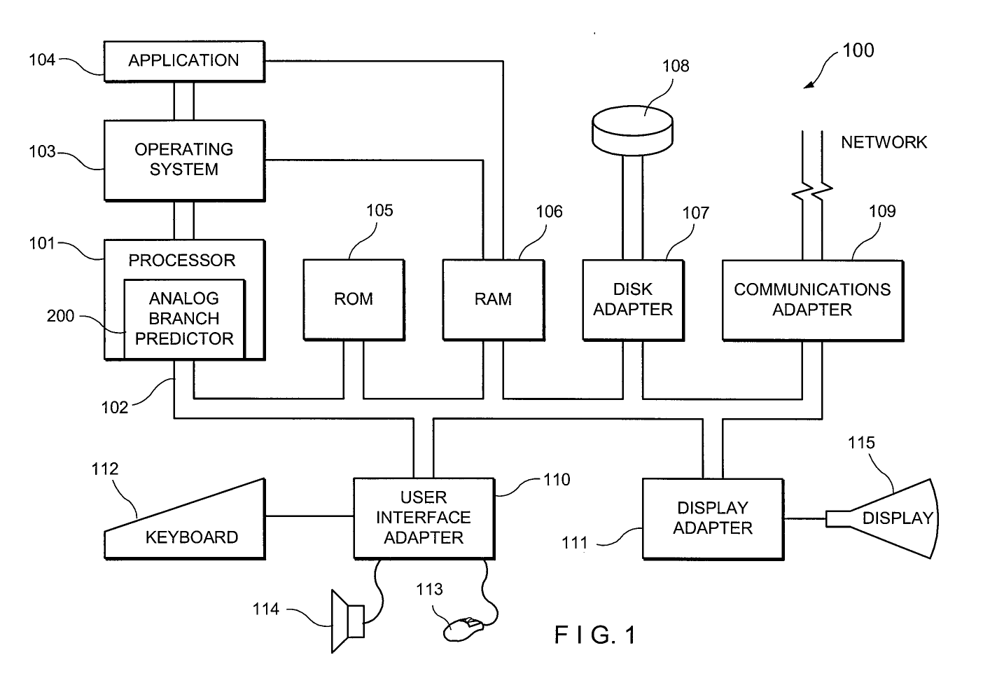

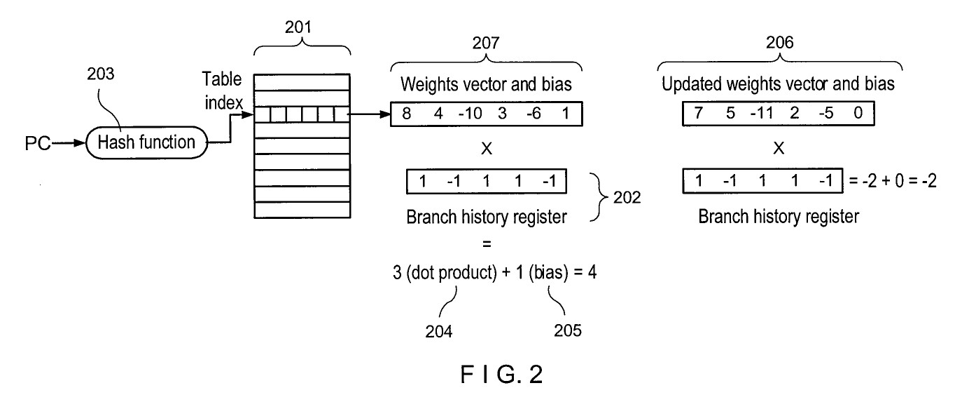

FIG. 1 is a schematic illustration of a block diagram of a computing system 100 arranged in accordance with some examples. Computer system 100 is also representative of a hardware environment for the present disclosure. For example, computer system 100 may have a processor 101 coupled to various other components by a system bus 102. Processor 101 may have an analog branch predictor 200 configured in accordance with the examples herein. A more detailed description of processor 101 is provided below in connection with a description of the example shown in FIG. 2. Referring to FIG. 1, an operating system 103 may run on processor 101, and provide control and coordinate the functions of the various components of FIG. 1. An application 104 in accordance with the principles of examples of the present disclosure may execute in conjunction with operating system 103, and provide calls and/or instructions to operating system 103 where the calls/instructions implement the various functions or services to be performed by application 104.

Referring to FIG. 1, a read-only memory (“ROM”) 105 may be coupled to system bus 102, and can include a basic input/output system (“BIOS”) that can control certain basic functions of computer device 100. A random access memory (“RAM”) 106 and a disk adapter 107 may also be coupled to system bus 102. It should be noted that software components, including operating system 103 and application 104, may be loaded into RAM 106, which may be computer system's 100 main memory for execution. A disk adapter 107 may be provided which can be an integrated drive electronics (“IDE”) or parallel advanced technology attachment (“PATA”) adapter, a serial advanced technology attachment (“SATA”) adapter, a small computer system interface (“SCSI”) adapter, a universal serial bus (“USB”) adapter, an IEEE 1394 adaptor, or any other appropriate adapter that communicates with a disk unit 108, e.g., disk drive.

Referring to FIG. 1, computer system 100 may further include a communications adapter 109 coupled to bus 102. Communications adapter 109 may interconnect bus 102 with an external network (not shown) thereby facilitating computer system 100 to communicate with other similar and/or different devices.

Input/Output (“I/O”) devices may also be connected to computer system 100 via a user interface adapter 110 and a display adapter 111. For example, a keyboard 112, a mouse 113 and a speaker 114 may be interconnected to bus 102 through user interface adapter 110. Data may be provided to computer system 100 through any of these example devices. A display monitor 115 may be connected to system bus 102 by display adapter 111. In this example manner, a user can provide data or other information to computer system 100 through keyboard 112 and/or mouse 113, and obtain output from computer system 100 via display 115 and/or speaker 114.

The various aspects, features, embodiments or implementations of the invention described herein can be used alone or in various combinations. The methods of the present invention can be implemented by software, hardware or a combination of hardware and software. A detailed description of a branch predictor design according to one example that may be implemented using processor 101 is provided below in connection with FIG. 2.

Many neural branch predictors can be derived from a perceptron branch predictor. In this example context, a perceptron can be a vector of h+1 small integer weights, where h is the history length of the predictor. Referring to FIG. 2, a table 201 of n perceptrons may be maintained in a fast memory. A global history shift register 202 of h most recent branch outcomes (1 for taken, 0 not taken) may also be maintained. The shift register 202 and table of perceptrons 201 can be analogous to the shift register and table of counters in traditional global two-level predictors, since both the indexed counter and the indexed perceptron may be used to determine the prediction.

As an example, to predict a branch, a perceptron (e.g., a weights vector) 207 may be selected using a hash function 203 of the branch program count (PC). The output of the perceptron 207 may be determined as a dot product 204 of the perceptron 207 and the history shift register 202, with the 0 (not-taken) values in the shift registers being interpreted as −1. Added to the dot product 204 may be an extra bias weight 205 in the perceptron 207, which can take into account the tendency of a branch to be taken or not taken, without regard for its correlation to other branches. If the dot-product 204 result is at least 0, then the branch is predicted as being taken; otherwise, it is predicted as being not taken. Negative weight values generally denote inverse correlations. For example, if a weight with a −10 value is multiplied by −1 in the shift register (i.e., not taken), the value −1·−10=10 will be added to the dot-product result, biasing the result toward a taken prediction since the weight indicates a negative correlation with the not-taken branch represented by the history bit. The magnitude of the weight may indicate the strength of the positive or negative correlation. As with other predictors, the branch history shift register 202 may be speculatively updated and rolled-back to the previous entry on a misprediction.

When the branch outcome becomes known, the perceptron 207 that provided the prediction may be updated [206]. The perceptron 207 may be trained based on a result of a misprediction or when the magnitude of the perceptron output is below a specified threshold value. Upon training, both the bias weight 205 and the h correlating weights can be updated. The bias weight 205 may be incremented or decremented if the branch is taken or not taken, respectively. Each correlating weight in the perceptron 207 may be incremented if the predicted branch has the same outcome as the corresponding bit in the history register (e.g., a positive correlation) and decremented otherwise (e.g., a negative correlation) using a saturating arithmetic procedure. If there is no correlation between the predicted branch and a branch in the history register, the latter's corresponding weight may tend toward 0. If there is a high positive or negative correlation, the weight may have a large magnitude.

Neural predictors, however, have traditionally shown poor power and energy characteristics due to certain computation requirements. Certain prior designs have somewhat reduced the predictor latency at the expense of some accuracy, but still remained unimpressive from a power perspective. As indicated above, the preference of determining a dot product for every prediction, with potentially tens or even hundreds of elements, not suitable for industrial adoption in their current form. Described herein below is an example of an analog implementation of such a neural predictor, which may significantly reduce the power requirements of the traditional neural predictor.

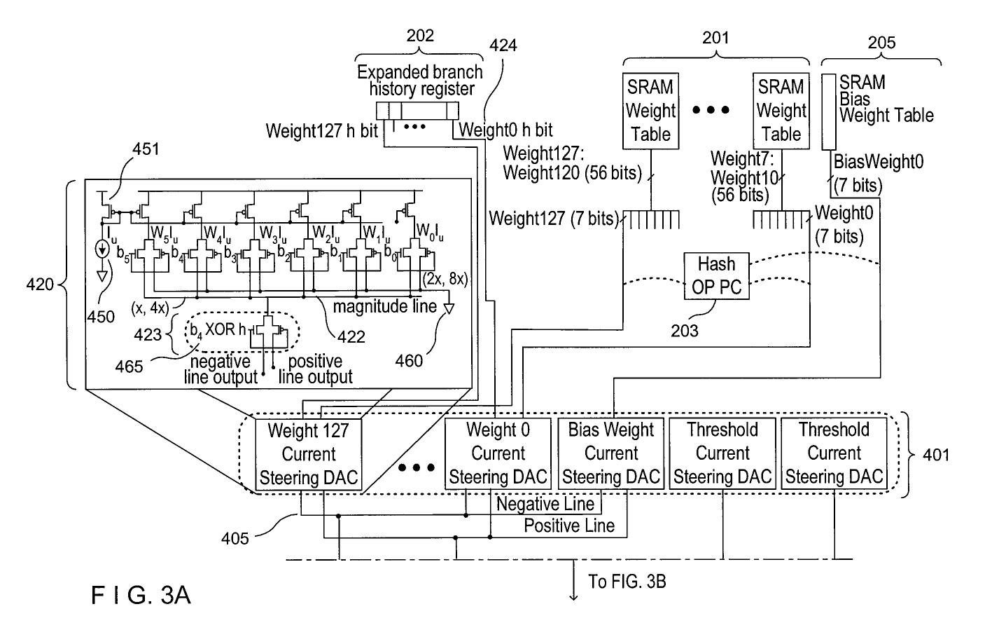

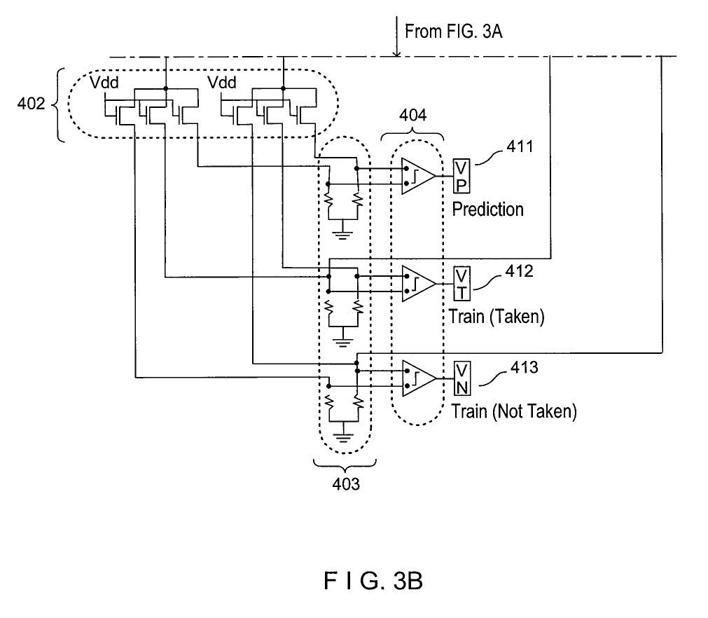

FIG. 3 illustrates a block and flow diagram of an example of an implementation of the neural analog predictor according to the present disclosure. Such predictor may function to efficiently determine the dot product of a vector of signed integers, represented in sign-magnitude form and a binary vector, to produce a taken or not-taken prediction, as well as a train/don't train output based on a threshold value. This example of a predictor may utilize analog current-steering and summation techniques to execute the dot-product operation. The example of a circuit design shown in FIG. 3 may consist of the following components: current steering digital-to-analog converters (DACs) 401, current splitters 402, current to voltage converters 403, comparators 404, and others.

For example, DACs 401 can include binary current-steering DACs 401. With digital weight storage, DACs 401 may be required to used digital weight values to analog values that can be combined efficiently. Although the perceptron weights can be 7 bits, 1 bit may be used to represent the sign of the weight, and 6-bit DACs are generally utilized. There may be, e.g., one DAC 401 per weight, each possibly consisting of a current source 450 and a bias transistor 451, as well as one transistor corresponding to each bit in the weight. One example of a sample DAC 401 is illustrated in greater detail in block 420, which also shows sample components thereof.

This example can support a near-linear digital-to-analog conversion. For example, for a 4-bit base-2 digital magnitude, the width of the DAC 401 transistor may be set to 1, 2, 4 and 8, and can draw currents, e.g., I, 2I, 4I, and 8I, respectively, as shown in greater detail at block 420. A switch can be used to steer each transistor current according to its corresponding weight bit, where, e.g., a weight bit of 1 may steer the current to the magnitude line [422] and a weight bit of 0 can steer it to ground [460]. In this example, if the digital magnitude to be converted is 5, or 0101, currents I and 4I may be steered to the magnitude line, where 2I and 8I may be steered to ground [460]. Based on the properties of Kirchhoff's current law, the magnitude line [422] can contain the sum of the currents whose weights bits are 1, and thus may approximate the digitally stored weight. The magnitude value may then be steered to a positive line or negative line [423] based on the XOR [465] of the sign bit for that weight and the appropriate history bit 424, effectively multiplying the signed weight value by the history bit 424. The positive and negative lines [423] may be shared across all weights, and again based on Kirchhoff's current law, all positive values can be added together, while all negative values may also be added together [405].

Thereafter, the results can be provided to the current splitter 402. For example, the currents on the positive line and the negative line may be split roughly equally by e.g., three transistors of the current splitter 402 to allow for three circuit outputs: a one-bit prediction and two bits that may be used to determine whether training should occur [412 and 413]. Splitting the current, rather than duplicating it through additional current mirrors, can maintain the relative relationship of the positive and negative weights without increasing the total current draw, thereby likely avoiding or reducing an increase in power consumption.

The outputs of the current splitter can be provided to the current to voltage converter 403. For example, the currents from the splitters 402 can pass through resistors of the current to voltage converter 403, thus creating voltages that may be used as input to the voltage comparators 404. For example, track-and-latch comparators 404, the examples shown in FIG. 3, can be used, as they may have the benefits of high-speed capability and simplicity. The comparators 404 may compare voltages associated with the magnitude of the positive weights, and those associated with the magnitude of the negative weights. The comparators 404 may function as, e.g., a one-bit analog to digital converter (ADC), and can use positive feedback to regenerate the analog signal into a digital signal. The comparators 404 may output, e.g., a value of 1 if the voltage corresponding to the positive line outweighs the negative line, and a value of 0 otherwise. For comparator output P [411], e.g., a value of 1 may correspond to a taken prediction, and a value of 0 may correspond to a not-taken prediction.

In addition to a one-bit taken or not-taken prediction [411], the example of the circuit may latch two signals [412 and 413] that can be used when the branch is resolved to indicate whether the weights are to be updated. Training may occur if, e.g., the prediction was incorrect or if the absolute value of the difference between the positive and negative weights is less than the threshold value. Rather than actually determining the difference between the positive and negative lines, which would likely require the use of more complex circuitry, the absolute value comparison may be split into two separate cases, e.g., one case for the positive weights being larger than the negative weights and the other case for the negative weights being larger than the positive ones. Instead of waiting for the prediction output P [411] to be produced, which may increase the total circuit delay, all three comparisons [411-413] may be performed in parallel, as is illustrated in FIG. 3.

For example, “T” [412] is the relevant training bit if the prediction is taken, and “N” [413] is the relevant training bit if the prediction is not taken. To produce bit “T” [412], the threshold value may be added to the current on the negative line. If the prediction “P” [411] is 1 (taken) and the “T” [412] output is 0, which means the negative line (with the threshold value added) is larger than the positive line, then the difference between the positive and negative weights may be less than the threshold value and the predictor should train. Similarly, to produce bit “N” [413], the threshold value may be added to the current on the positive line. If the prediction “P” [411] is 0 (not taken) and the “N” [413] output is 1, which means the positive line (with the threshold value added) is larger than the negative line, then the difference between the negative and positive weights is less than the threshold value.

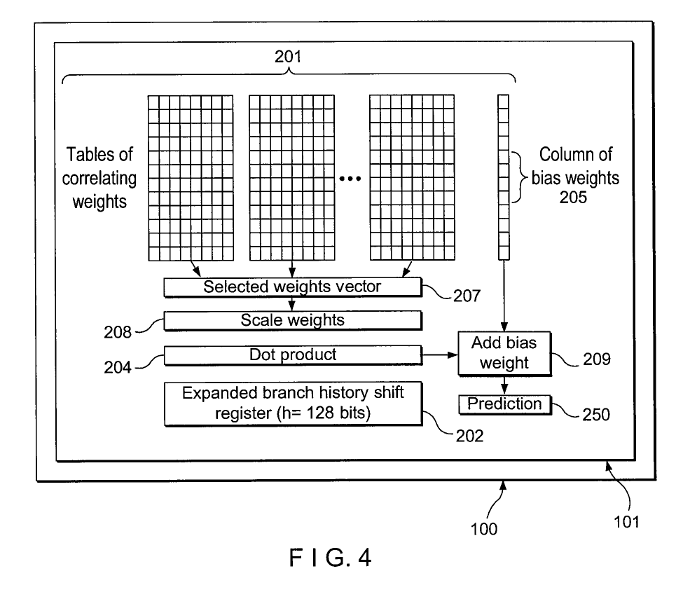

FIG. 4 shows a block and flow diagram of a system, method and computer-accessible medium according to one example. An additional component of the example of the present invention may include a scaling factor, where, as shown is FIG. 4, the vector weights can be scaled according to a given function f(i), in which i can represent the position in the vector of the given weight bit. The vector of weight can represent the contribution of each branch in a given history to predictability, while each branch generally does not contribute equally. For example, more recent weights may have a stronger correlation with branch outcomes.

In particular, FIG. 3 shows a flow and block diagram of one example of a method, system, and computer-accessible medium that can implement such scaling factor in conjunction with the neural analog predictor discussed above. The computer system 100 can include processor 101, using which the following procedures can be executed. First, at least one weights vector may be selected from table of perceptrons [201, 207]. The selected weights vector(s) may then be multiplied or effected by the appropriate function f(i) [208]. In one example, the function f(i) may be represented by the equation f(i)=1/(a+bi), where a=0.1111, and b=0.037. Other coefficients a and b may be used, as appropriate to the particular design of the circuit or arrangement. The dot product of this vector and the branch history register 202 may then be taken [204]. Further, the bias weight 205 may be added [209], which can produce the prediction [250] as discussed above.

Disclosed in some examples is a method for providing a branch prediction using at least one analog branch predictor, comprising obtaining at least one current approximation of weights associated with correlations of branches to the branch predictions, and generating the branch predictions based on the at least one current approximation. In other examples, obtaining at least one current approximation comprises selecting a first vector from a table of weights, selecting a second vector from a global history shift register, converting the first and second vectors from a digital format to an analog format, and computing a dot product of the vectors. In further examples, the method may include adding a bias weight to the dot product of the vectors. In other examples, the first vector is selected from a table of weights using a hash function. In still other examples, the first and second vectors are converted using one or more binary current steering digital to analog converters. While in further examples, the dot product of the first and second vectors is obtained using a current summation. In some examples, the method may further comprise converting the dot product using a comparator acting as an analog to digital converter to convert the dot product of the vectors. In other examples, the method may further comprise scaling the vector from the table of weights. In further examples, the scaling is accomplished using a scaling factor according to the equation f(i)=1/(0.1111+0.037i), where i is a position in the first vector, and f(i) is a value representing the scaling factor. In still further examples, the method may additionally comprise updating the vector from the table of weights based on an accuracy of a previous prediction.

Disclosed in other examples is a processing arrangement which when executing a software program is configured to obtain at least one current approximation of weights associated with correlations of branches to the branch predictions, and generate the branch predictions based on the at least one current approximation. In some examples, the configuration for obtaining at least one current approximation comprises a sub-configuration configured to select a first vector from a table of weights, select a second vector from a global history shift register, convert the first and second vectors from a digital format to an analog format, and compute a dot product of the vectors. In further examples, the arrangement may be further configured to add a bias weight to the dot product of the vectors. In yet further examples, the first vector is selected from a table of weights using a hash function. While in other examples, the first and second vectors are converted using one or more binary current steering digital to analog converters. In still other examples, the dot product of the first and second vectors is obtained using a current summation. While in other examples, the arrangement may be further configured to convert the dot product using a comparator acting as an analog to digital converter to convert the dot product of the vectors. And in other examples, the arrangement may be further configured to update the vector from the table of weights based on an accuracy of a previous prediction.

Disclosed in yet other examples is a computer accessible medium having stored thereon computer executable instructions for branch prediction within an analog branch predictor, wherein when a processing arrangement executes the instructions, the processing arrangement is configured to perform procedures comprising obtaining at least one current approximation of weights associated with correlations of branches to the branch predictions, and generating the branch predictions based on the at least one current approximation. In other examples, obtaining at least one current approximation comprises selecting a first vector from a table of weights, selecting a second vector from a global history shift register, converting the first and second vectors from a digital format to an analog format, and computing a dot product of the vectors.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells or cores refers to groups having 1, 2, or 3 cells or cores. Similarly, a group having 1-5 cells or cores refers to groups having 1, 2, 3, 4, or 5 cells or cores, and so forth.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

What is claimed is:

1. A method for providing branch predictions using analog a branch predictor, comprising:
providing first branch-predictions;
obtaining a current approximation of weights associated with correlations of branches to the first branch-predictions; and
generating second branch-predictions based on the at least one current approximation.

2. The method of claim 1, wherein the current approximation is obtained by:
selecting a first vector from a table of the weights;
selecting a second vector from a global history shift register;
converting the first and second vectors from a digital format to an analog format; and
computing a dot product of the analog vectors.

3. The method of claim 2, further comprising adding a bias weight to the dot product.

4. The method of claim 2, wherein the first vector is selected from the table of the weights using a hash function.

5. The method of claim 2, wherein the first and second vectors are converted to the analog format using one or more binary current steering digital-to-analog converters.

6. The method of claim 2, wherein the dot product is obtained using a current summation.

7. The method of claim 2, further comprising converting the dot product from an analog to a digital format using a comparator.

8. The method of claim 2, further comprising scaling one or both of the vectors, wherein the dot product is computed based on the scaled vectors.

9. The method of claim 8, wherein the scaling is conducted uses a scaling factor according to the equation f(i)=1/(0.1111+0.037i), where i is a position in the first vector and f(i) is the scaling factor.

10. The method of claim 2, further comprising updating one or both of the vectors on the table based on an accuracy of a previous prediction.

11. A processing arrangement which when executing a software program is configured to perform processing procedures comprising:
providing first branch-predictions;
obtaining a current approximation of weights associated with correlations of branches to the first branch-predictions; and
generating second branch-predictions based on the at least one current approximation.

12. The processing arrangement of claim 11, wherein the processing procedures for obtaining of the current approximation are configured for:
selecting a first vector from a table of the weights;
selecting a second vector from a global history shift register;
converting the first and second vectors from a digital format to an analog format; and
computing a dot product of the analog vectors.

13. The processing arrangement of claim 12, further configured to add a bias weight to the dot product of the vectors.

14. The processing arrangement of claim 12, wherein the first vector is selected from the table of the weights using a hash function.

15. The processing arrangement of claim 12, wherein the first and second vectors are converted to the analog format using one or more binary current steering digital-to-analog converters.

16. The processing arrangement of claim 12, wherein the dot product of the first and second vectors is obtained using a current summation.

17. The processing arrangement of claim 12, further configured to convert the dot product from an analog to a digital format using a comparator.

18. The processing arrangement of claim 12, further configured to update one or both of the vectors on the table based on an accuracy of a previous prediction.

19. A computer accessible medium having stored thereon computer executable instructions for branch prediction within an analog branch predictor, wherein when a processing arrangement executes the instructions, the processing arrangement is configured to perform procedures comprising:
providing first branch-predictions;
obtaining a current approximation of weights associated with correlations of branches to the first branch-predictions; and
generating second branch-predictions based on the at least one current approximation.

20. The computer accessible medium of claim 19, wherein the at least one current approximation is obtained by:
selecting a first vector from a table of the weights;
selecting a second vector from a global history shift register;
converting the first and second vectors from a digital format to an analog format; and
computing a dot product of the analog vectors.
